(19) United States
(12) Patent Application Publication
(10) Pub. No.: US 2026/0109404 A1
(43) Pub. Date: Apr. 23, 2026

(54) CENTER PILLAR OUTER PART FOR VEHICLE AND ITS MANUFACTURING METHOD

(71) Applicants: Hyundai Motor Company, Seoul (KR); Kia Corporation, Seoul (KR); HYUNDAI STEEL COMPANY, Incheon (KR)

(72) Inventors: Chang Wook Lee, Hwaseong-si (KR); Yeonjung Hwang, Hwaseong-si (KR); Donghyun Kim, Suwon-si (KR); Uk Heo, Hwaseong-si (KR)

(21) Appl. No.: 19/252,924

(22) Filed: Jun. 27, 2025

(30) Foreign Application Priority Data
Oct. 22, 2024 (KR) 10-2024-0144888

(51) Int. Cl. B62D 25/04

(52) U.S. Cl. CPC B62D 25/04

(57) ABSTRACT

A center pillar outer part for a vehicle and a method for manufacturing the same are disclosed. The center pillar outer part for the vehicle includes an upper blank, a middle blank, and a lower blank made of different materials. The middle blank and the lower blank are joined through a laser welding to form a laser welded blank (LWB), and the upper blank and the LWB are joined through a spot welding and then formed into an integral structure through a hot stamping method.

### CROSS-REFERENCE TO RELATED APPLICATIONS

This application claims priority to and the benefit of Korean Patent Application No. 10-2024-0144888 filed with the Korean Intellectual Property Office on Oct. 22, 2024, the entire contents of which are incorporated herein by reference.

### TECHNICAL FIELD

The present disclosure relates to a center pillar outer part for a vehicle and a method for manufacturing the same, and more specifically, to a center pillar outer part for a vehicle manufactured using a TWB (Tailor Welded Blank) hot stamping technique and a method for manufacturing the same.

### BACKGROUND

A center pillar outer, which is generally applied to a vehicle body, is configured to absorb an external impact in an event of a side collision and minimize a collision penetration into the interior.

The conventional center pillar outer has two reinforcements added to the lower end part to secure a side impact performance. However, there is a disadvantage in that the weight increases due to the two additional reinforcements assembled at the lower end part of the center pillar outer, and the increase in the weight of the body causes a decrease in fuel efficiency.

Meanwhile, under the latest enhanced crash tests (e.g. Insurance Institute for Highway Safety (IIHS) 2023 crash tests), the weight of the barrier that the test vehicle collides with will increase from 1.5 tons to 1.9 tons, and the speed will increase from 50 km/h to 60 km/h to meet more severe crash test conditions.

Such an enhancement of the marketability according to the vehicle's collision performance may cause an increase in the vehicle's body weight, which may worsen the fuel efficiency. Therefore, it is necessary to develop a new center pillar outer structure that can simultaneously suppress the increase in the body weight and satisfy the collision performance.

The above information disclosed in this Background section is only for enhancement of understanding of the disclosure, and therefore, it may contain information that does not constitute prior art.

### SUMMARY

An embodiment of the present disclosure is to provide a vehicle center pillar outer part capable of suppressing a body weight increase and satisfying a crash performance at the same time, and a method for manufacturing the same, by deleting reinforcing materials added for a side impact reinforcement in the prior art, forming an integral tailor welded blank (TWB) assembly by laser and spot welding of three-piece blanks of different materials, and forming the TWB assembly by a hot stamping.

According to one aspect of the present disclosure, a center pillar outer part for a vehicle include a three-piece blank of an upper blank, a middle blank, and a lower blank made of different materials, wherein the middle blank and the lower blank are joined through a laser welding to form a laser welded blank (LWB), and the upper blank and the LWB are joined through a spot welding and then formed into an integral structure through a hot stamping method.

The length of the upper blank may be formed at a ratio of 60 to 80% of the total length.

The length of the upper blank may be formed to cover the laser welded portion formed on the LWB.

The length of the middle blank may be formed at a ratio of 10 to 30% of the total length.

The length of the lower blank may be formed at a ratio of 20 to 40% of the total length.

The length of the LWB may be formed at a ratio of 50 to 70% of the total length.

On the other hand, according one aspect of the present disclosure, a manufacturing method of a center pillar outer part for a vehicle includes producing a three-piece blank including an upper blank, a middle blank, and a lower blank by shearing different materials into different lengths through a blanking device; forming an integral tailor welded blank (TWB) assembly by joining the three-piece blanks using a laser welder and a spot welder; and manufacturing a center pillar outer part formed into an integral structure by pressing and processing the TWB assembly using a hot stamping method.

Also, producing the three-piece blank may include manufacturing the length of the upper blank at a rate of 60 to 80% of the total length; manufacturing the length of the middle blank at a ratio of 10 to 30% of the total length; and manufacturing the length of the lower blank at a ratio of 20 to 40% of the total length.

Also, forming the TWB assembly may include forming a laser welded blank (LWB) by joining the lower blank and the middle blank together and then laser welding them; and overlapping a portion of the upper blank on the LWB in the longitudinal direction and then spot welding it to form the integral TWB assembly.

When spot-welding the LWB and the upper blank, the upper blank may be welded to the front or back surface of the LWB.

When spot welding the LWB and the upper blank, the length of the upper blank may be welded so as to cover the laser weld formed on the LWB.

The hot stamping method may include heating the TWB assembly to a predetermining forming temperature through a heater; loading the heated TWB assembly into a hot stamping mold and then pressurizing it to be press-formed; and rapidly cooling the TWB assembly through a cooling device with the pressed state during the press forming.

According to an embodiment of the present invention, by manufacturing the center pillar outer part using the three-piece blank without a separate reinforcing agent, there is an effect of improving a driving distance due to a vehicle weight reduction and reducing a cost of parts through the reduction of reinforcing agents and a development of a simple structure.

In addition, by adjusting the length ratio of the upper blank, middle blank, and lower blank that make up the center pillar outer part to satisfy the required strength and toughness of each part of the component, there is an effect of absorbing the impact energy of the lower part in the event of the side collision and securing a passenger survival space in the upper part.

### BRIEF DESCRIPTION OF THE DRAWINGS

FIG. 1 is a view illustrating a center pillar outer structure utilizing a TWB hot stamping according to an embodiment of the present disclosure.

FIG. 2 is a flow chart illustrating a method for manufacturing a vehicle center pillar outer part according to an embodiment of the present disclosure.

FIG. 3 is a view showing a process system for manufacturing a vehicle center pillar outer part according to an embodiment of the present disclosure.

FIG. 4 is a view showing dimensions of a part applicable when manufacturing a vehicle center pillar outer part according to an embodiment of the present disclosure.

FIG. 5 is a view showing an IIHS side impact analysis result according to changes in an upper blank length according to an embodiment of the present disclosure.

### DETAILED DESCRIPTION OF ILLUSTRATIVE EMBODIMENTS

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

The terminology used herein is for the purpose of describing particular embodiments only and is not intended to be limiting of the present disclosure. As used herein, the singular forms are intended to include the plural forms as well, unless the context clearly indicates otherwise. The terms “comprise” and/or “comprising”, when being used in the present specification, specify the presence of the mentioned features, integers, steps, operations, constituent elements, and/or components, but it will also be appreciated that at least presence or addition of other features, integers, steps, operations, constituent elements, components, and/or groups thereof is not excluded. As used herein, the term “and/or” includes any one or all combinations of the items listed in association.

Throughout the specification, terms such as “first”, “second”, “A”, “B”, “(a)”, “(b)” etc. may be used to describe various elements, but the elements should not be limited by the terms. These terms are used only to differentiate the components from other components, but the nature, sequence, order, etc. of the corresponding components are not limited by these terms.

Also, in this specification, it is to be understood that when one component is referred to as being “connected” or “coupled” to another component, it may be connected or coupled directly to the other component or be connected or coupled to the component with another component intervening therebetween. On the other hand, in this specification, it is to be understood that when one component is referred to as being “connected or coupled directly” to another component, it may be connected or coupled to the other component without another component intervening therebetween.

It is also to be understood that the terminology used herein is only for the purpose of describing particular embodiments, and is not intended to be limiting of the disclosure. Singular forms are to include plural forms unless the context clearly indicates otherwise.

Now, a center pillar outer structure utilizing TWB hot stamping according to an embodiment of the present disclosure and a manufacturing method thereof will be described in detail with reference to accompanying drawings.

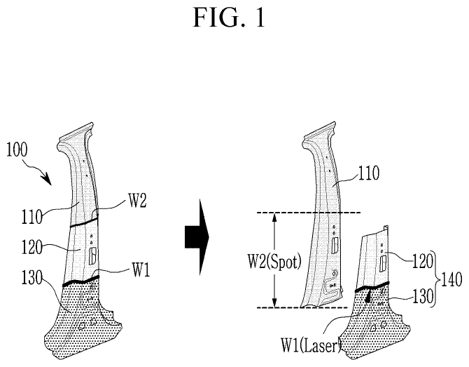

FIG. 1 is a view illustrating a center pillar outer structure utilizing TWB hot stamping according to an embodiment of the present disclosure.

Referring to FIG. 1, a center pillar outer part 100 manufactured using a tailor welded blank (TWB) hot stamping method according to an embodiment of the present disclosure may be manufactured as a three-piece blank of an upper blank 110, a middle blank 120, and a lower blank 130 having different strengths. The middle blank 120 and the lower blank 130 are joined through a laser welding portion W1 to form a laser welded blank (LWB) 140, and the upper blank 110 and the LWB 140 are joined through a spot welding portion W2 and then formed into an integral structure through a hot stamping method.

Hereinafter, the upper blank 110, the middle blank 120, and the lower blank 130 may be named as an upper portion 110, a middle portion 120, and a lower portion 130 depending on the area to which they are applied to the center pillar outer part 100 after being formed into the integral structure.

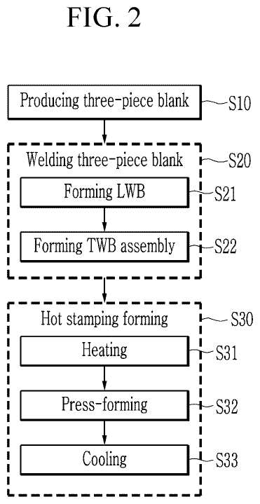

FIG. 2 is a flow chart illustrating a method for manufacturing a vehicle center pillar outer part according to an embodiment of the present disclosure.

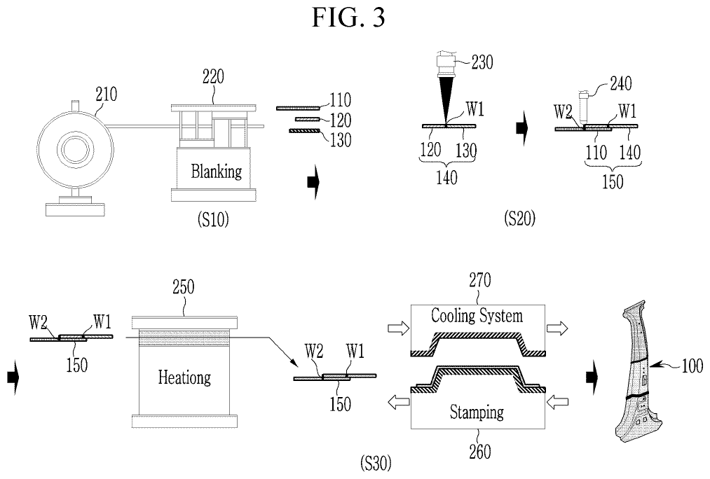

FIG. 3 is a view showing a process system for manufacturing a vehicle center pillar outer part according to an embodiment of the present disclosure.

Referring to FIG. 2 and FIG. 3, a method for manufacturing a vehicle center pillar outer part includes manufacturing a three-piece blank 110, 120, 130 (S10), forming an integral TWB assembly 150 (S20), and manufacturing a center pillar outer part (S30).

In manufacturing the three-piece blank 110, 120, 130 (S10), the three-piece blank 110, 120, 130 may be manufactured by shearing a material to different lengths through a blanking device (210).

In the forming the integral TWB assembly 150 (S20), the three-piece blanks 110, 120 and 130 may be joined (bonded) using a laser welder 220 and a spot welder 230 to form the integral TWB assembly 150.

In the step (S30) of manufacturing a center pillar outer part, the TWB assembly (150) can be press-processed using a hot stamping method to manufacture a center pillar outer part formed into an integral structure.

The three-piece blanks 110, 120, and 130 may be manufactured to have different materials, strengths, toughness and/or thicknesses depending on the application area of the part.

Typically, the center pillar outer part 100 serves to connect the bottom surface of the vehicle body and the roof between the front door and the rear door. The center pillar outer part 100 requires high strength in areas where it must maintain the shape thereof to ensure the survival of passengers in the event of a vehicle collision or a rollover (e.g., the upper and middle portions), and relatively low strength in areas where it must absorb an impact energy (e.g., the lower portion).

Therefore, the upper blank 110 and the middle blank 120 of the center pillar outer part 100 may be made of a first material (e.g., a boron steel) with high strength and low toughness to maintain the roof shape when the vehicle rolls over. Also, the lower blank 130 may be applied with a second material (e.g., a general cold rolled steel) having relatively low strength and high toughness to absorb the impact energy.

Manufacturing the three-piece blanks 110, 120, and 130 (S10) is specifically described.

The three-piece blanks 110, 120, and 130 are manufactured by a blanking device 210.

The three-piece blanks 110, 120, 130 include an upper blank 110, a middle blank 120, and a lower blank 130 depending on the application area of the center pillar outer part100.

The length of the three-piece blanks 110, 120, 130 may be manufactured in various ratios according to the design concept of the applicable vehicle type.

However, the center pillar outer part 100 according to the embodiment of the present disclosure can be manufactured at the following ratio in order to satisfy the strength and toughness required for each part of the part due to its structural characteristics of being composed of a combination of three-piece blanks (110, 120, 130) by removing the two reinforcing agents applied to the parts of the prior art.

For example, the length of the upper blank 110 may be manufactured at the ratio of 60 to 80% of the total length of the center pillar outer part 100. At this time, the length of the upper blank 110 may be manufactured to the length that may cover the laser welded portion W1 formed on the LWB 140. Additionally, when a local collision occurs on the lower blank 130, the length of the upper blank 110 may be adjusted so that the deformation occurs centered on the collision location of the lower blank 130.

Additionally, the length of the intermediate blank 120 may be manufactured at the ratio of 10 to 30% of the total length of the center pillar outer part 100.

Additionally, the length of the lower blank 130 may be manufactured at the ratio of 20 to 40% of the total length of the center pillar outer part 100.

In addition, the length of the LWB 140 combining the lower blank 130 and the middle blank 120 may be manufactured at the ratio of 50 to 70% of the total length of the center pillar outer part 100.

The length ratios of these three-piece blanks 110, 120, 130 are set by comprehensively considering the analysis conditions and results of the IIHS 2.0 side impact bogie test and the IIHS roof crush load test conducted with various ratios and/or combinations thereof.

For example, the IIHS 2.0 side impact bogie test is conducted under the conditions of the side impact bogie weight of 1900 kg and a speed of 60 km/h to evaluate the degree of securing survival space. The IIHS ceiling strength load test may evaluate the strength of the vehicle body by applying a load to the ceiling of the vehicle at a speed of 12.7 mm/s.

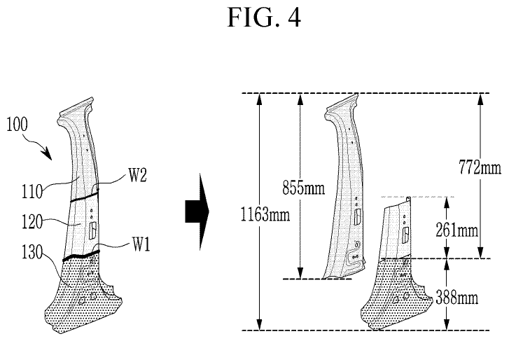

FIG. 4 is a view showing dimensions of parts applicable when manufacturing a vehicle center pillar outer part according to an embodiment of the present disclosure.

Referring to FIG. 4, the center pillar outer part 100 according to one embodiment of the present disclosure may be manufactured with the length of the upper blank 110 being 73.5% of the total length of the center pillar outer part 100, the length of the middle blank 120 being 22.4% of the total length of the center pillar outer part 100, and the length of the lower blank 130 being 33.4% of the total length of the center pillar outer part 100.

At this time, the upper blank 110 is manufactured with a sufficient length so that the lower end may cover the laser welding part W1.

Additionally, the length of the middle blank 120 may be changed depending on the length of the lower blank 130. However, when the length of the LWB 140 exceeds 60% of the total length of the part, the weight reduction effect is reduced.

Therefore, the length of the middle blank 120 can be set to be changeable according to the length of the lower blank 130, and the length of the LWB 140 two blanks 120 and 130 may be manufactured so that it does not exceed 60% of the total length of the center pillar outer part 100. Also, it may be limited to not exceed 70%.

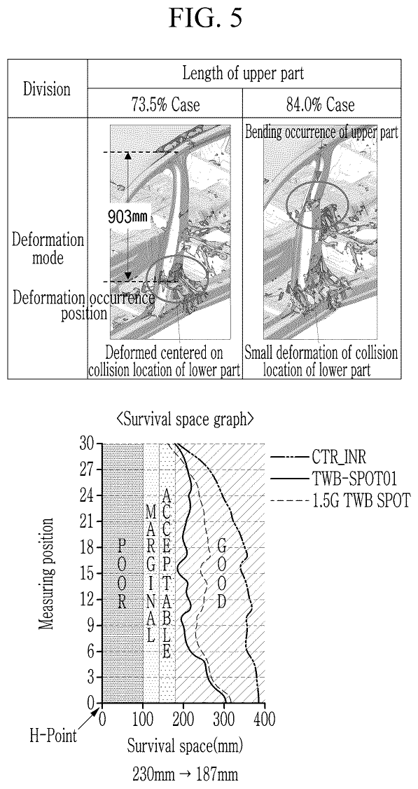

FIG. 5 is a view showing IIHS side impact analysis results according to changes in an upper blank length according to an embodiment of the present disclosure.

Referring to FIG. 5, the IIHS side impact analysis results are shown for cases where the length of the upper blank 110 of the center pillar outer part 100 is 73.5% and 84%, as in FIG. 4 above.

When the length of the upper blank 110 is 73.5%, the impact energy is absorbed as the deformation occurs around the impact location of the lower blank 130, and the sufficient survival space may be secured without the deformation of the upper blank 110.

On the other hand, when the length of the upper blank 110 is increased to 84%, it may be confirmed that the deformation at the impact location of the lower blank 130 is small, so that the impact energy may be not absorbed and the upper blank 110 may be bent, resulting in a problem of the reduced survival space. That is, it may be confirmed that when the length of the upper blank increases from 73.5% to 84%, the survival space decreases by approximately 19% from 230 mm to 187 mm.

That is, the increase in the length of the upper blank 110 strengthens the lower blank 130, and causes the deformation of the upper blank 110 (i.e., the non-overlapping portion) which is relatively thin, resulting in the disadvantage of the reduced survival space.

Therefore, according to one embodiment, when a local collision occurs on the lower blank 130, the length of the upper blank 110 may be set to 80% or less of the total length of the center pillar outer part 100 so that the deformation occurs centered on the collision location of the lower blank 130.

Through this, the rigidity of the area including the middle blank 120 overlapping the upper blank 110 and the laser welded portion W1 in the entire area of the LWB 140 may be strengthened, and the area of the remaining lower blank 130 may be have the relatively softened characteristic.

Accordingly, the upper blank 110 is formed in a state where it overlaps the laser welded portion W1 via the middle blank 120 of the LWB 140, so that the rigidity of the impact location of the middle blank 120 is strengthened during a side impact (or a test), and the lower blank 130 is prevented from overlapping, thereby inducing the overall deformation of the lower blank 130 due to the impact through a local softening.

Referring again to FIG. 2, forming the TWB assembly 150 (S20) may include forming the LWB 140 (S21), and forming the integral TWB assembly 150 (S22).

In forming the LWB 140 (S21), the lower blank 130 and the middle blank 120 to which different materials are applied are placed against each other and then laser-welded to form the LWB 140 in which the lower blank 130 and the middle blank 120 are combined.

In forming the integral TWB assembly 150 (S22), a portion of the upper blank 110 may be overlapped on the LWB 140 in the longitudinal direction, and then the LWB 140 and the upper blank 110 may be spot-welded to form the integral TWB assembly 150.

When spot-welding the LWB 140 and the upper blank 110, the upper blank 110 may be welded to the front or back surface of the LWB 140.

In addition, when spot-welding the LWB 140 and the upper blank 110, of the upper blank 110 may be welded for the length so as to cover the laser welding portion W1 formed on the LWB 140.

Forming the center pillar outer part by the hot stamping method (S30) includes heating the TWB assembly 150 to a predetermined forming temperature using a heater 240 (S31), loading the heated TWB assembly 150 into a hot stamping mold 250 and press-forming it (S32), and rapidly cooling the TWB assembly 150 while in a press-formed state using a cooling device 260 during the press-forming process (S33).

In this process, the integral TWB assembly 150 is heated to the predetermined temperature, then press-formed using the hot stamping mold 260, and the assembly is rapidly cooled, thereby manufacturing the center pillar outer part 100 with reduced weight and improved crash performance.

In this way, according to an embodiment of the present disclosure, by manufacturing the center pillar outer part using the three-piece blank without a separate reinforcing agent, there is an effect of improving a driving distance due to the vehicle weight reduction and reducing a cost of parts through the reduction of reinforcing agents and development of a simple structure.

In addition, by adjusting the length ratio of the upper blank, the middle blank, and the lower blank that make up the center pillar outer part to satisfy the required strength and toughness of each part of the component, there is an effect of absorbing the impact energy of the lower part in the event of the side collision and securing the passenger survival space in the upper part.

The above-mentioned exemplary embodiments of the present disclosure are not embodied only by an apparatus and/or method. Alternatively, the above-mentioned exemplary embodiments may be embodied by a program performing functions that correspond to the configuration of the exemplary embodiments of the present disclosure, or a recording medium on which the program is recorded. These embodiments can be easily devised from the description of the above-mentioned exemplary embodiments by those skilled in the art to which the present disclosure pertains.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

### Description of Symbols

100: center pillar outer
110: upper blank
120: middle blank
130: lower blank
140: LWB
150: TWB assembly
210: blanking device
220: laser welder
230: spot welder
240: heater
250: hot stamping mold
260: cooling device
W1: laser welding portion
W2: spot welding part

What is claimed is:

1. A center pillar outer part for a vehicle comprising:
an upper blank;
a middle blank; and
a lower blank,
wherein:
the upper blank, the middle blank, and the lower blank are made of different materials,
the middle blank and the lower blank are joined through a laser welding to form a laser welded blank (LWB), and
the upper blank and the LWB are joined through a spot welding and then formed into an integral structure of the center pillar outer part through a hot stamping method.

2. The center pillar outer part of claim 1, wherein:
an upper blank length of the upper blank is formed at a ratio of 60 to 80% of a total length of the center pillar outer part.

3. The center pillar outer part of claim 2, wherein:
the upper blank length of the upper blank is formed to cover a laser welded portion formed on the LWB.

4. The center pillar outer part of claim 1, wherein:
a middle blank length of the middle blank is formed at a ratio of 10 to 30% of a total length of the center pillar outer part.

5. The center pillar outer part of claim 1, wherein:
a lower blank length of the lower blank is formed at a ratio of 20 to 40% of a total length of the center pillar outer part.

6. The center pillar outer part of claim 1, wherein:
an LWB length of the LWB is formed at a ratio of 50 to 70% of a total length of the center pillar outer part.

7. A manufacturing method of a center pillar outer part for a vehicle, the manufacturing method comprising:
producing an upper blank, a middle blank, and a lower blank by shearing different materials into different lengths using a blanking device;
forming an integral tailor welded blank (TWB) assembly by joining the upper blank, the middle blank, and the lower blank using a laser welder and a spot welder; and
manufacturing the center pillar outer part formed into an integral structure by pressing and processing the integral TWB assembly using a hot stamping method.

8. The manufacturing method of claim 7, further comprising:
manufacturing an upper blank length of the upper blank at a first ratio of 60 to 80% of a total length of the center pillar outer part;
manufacturing a middle blank length of the middle blank at a second ratio of 10 to 30% of the total length; and
manufacturing a lower blank length of the lower blank at a third ratio of 20 to 40% of the total length.

9. The manufacturing method of claim 7, wherein forming the integral TWB assembly comprises:
forming a laser welded blank (LWB) by joining the lower blank and the middle blank together and then laser welding the lower blank and the middle blank; and
overlapping a portion of the upper blank on the LWB in a longitudinal direction and then spot welding the upper blank and the LWB to form the integral TWB assembly.

10. The manufacturing method of claim 9, wherein, when spot-welding the LWB and the upper blank, the upper blank is welded to a front surface or a back surface of the LWB.

11. The manufacturing method of claim 9, wherein, when spot-welding the LWB and the upper blank, the upper blank is welded so as to cover a laser weld formed on the LWB.

12. The manufacturing method of claim 7, wherein the hot stamping method comprises:
heating the integral TWB assembly to a predetermined forming temperature using a heater;
loading the heated integral TWB assembly into a hot stamping mold and then pressurizing the heated integral TWB assembly to be press-formed; and
rapidly cooling the heated, press-formed integral TWB assembly using a cooling device with a pressed state during press forming.

13. A vehicle, comprising:
a center pillar outer part comprising:
an upper blank made of a first material; and
a laser welded blank (LWB) comprising:
a middle blank made of a second material; and
a lower blank made of a third material,
wherein:
the upper blank and the LWB are joined and pressed to form the center outer pillar part.

14. The vehicle of claim 13, wherein the upper blank and the LWB are joined via spot welding.

15. The vehicle of claim 14, wherein the upper blank and the LWB joined via the spot welding are pressed via a hot stamping method to form the center pillar outer part.

16. The vehicle of claim 13, wherein the upper blank is 60% to 80% of a length of the center outer pillar part.

17. The vehicle of claim 13, wherein the middle blank is 10% to 30% of a length of the center outer pillar part.

18. The vehicle of claim 13, wherein the lower blank is 20% to 40% of a length of the center outer pillar part.

19. The vehicle of claim 13, wherein the LWB is 50% to 70% of a length of the center outer pillar part.

20. The vehicle of claim 13, wherein the center pillar outer part is configured to connect a bottom surface of a vehicle body of the vehicle with a roof of the vehicle between a front door of the vehicle and a rear door of the vehicle.
